(19) United States
(12) Patent Application Publication
(10) Pub. No.: US 2025/0145138 A1
(43) Pub. Date: May 8, 2025

(54) Lift Axle Braking System

(71) Applicant: Bendix Commercial Vehicle Systems LLC, Avon, OH (US)

(72) Inventors: Christopher H. Hutchins, Bay Village, OH (US); Ryan S. Hurley, Lakewood, OH (US); Alexander J. Augoustidis, Avon Lake, OH (US)

(73) Assignee: Bendix Commercial Vehicle Systems LLC, Avon, OH (US)

(21) Appl. No.: 18/387,214

(22) Filed: Nov. 6, 2023

(51) Int. Cl. B60T 13/68; B60T 8/17; B60T 8/176; B60T 13/26; B60T 17/04

(52) U.S. Cl. CPC B60T 13/683; B60T 8/1708; B60T 8/176; B60T 13/268; B60T 17/043

(57) ABSTRACT

A lift axle can be provided on a truck during or after manufacturing to allow the truck to carry more load. The lift axle can be selectively lifted above the road (e.g., when the truck is empty) and lowered onto the road (e.g., when carrying load requiring an extra axle). There are various challenges in designing a braking system for a lift axle. The embodiments presented herein provide a lift axle brake system that can overcome these challenges. In one embodiment, a lift axle brake system is used that is based on a brake system used to brake a towed vehicle towed by a towing vehicle. Other embodiments are provided.

### BACKGROUND

The amount of load a truck can carry is typically constrained by the number of axles on the truck. A lift axle can be provided on a truck during or after manufacturing to allow the truck to carry more load. The lift axle can be selectively lifted above the road (e.g., when the truck is empty) and lowered onto the road (e.g., when carrying load requiring an extra axle).

### BRIEF DESCRIPTION OF THE DRAWINGS

FIG. 1 is a diagram of a braking system of a towing vehicle of an embodiment.

FIG. 2 is a diagram of a braking system of a towing vehicle of an embodiment that uses a towed vehicle anti-lock brakes system (TABS) unit on a lift axle.

FIG. 3 is a diagram of a braking system of a towing vehicle of an embodiment that uses a controller area network (CAN)-connected TABS unit on a lift axle.

FIG. 4 is a diagram of a braking system of a truck of an embodiment.

FIG. 5 is a diagram of a braking system of a truck of an embodiment that uses a TABS unit on a lift axle.

FIG. 6 is a diagram of a braking system of a truck of an embodiment that uses a CAN-connected TABS unit on a lift axle.

### SUMMARY

In one embodiment, a brake system is provided comprising: an electronic trailer pressure control module comprising an input port and an output port; a braking controller configured to cause the electronic trailer pressure control module (eTPCM) to selectively allow pressurized air to flow from the input port to the output port; and a lift axle brake sub-system. The lift axle brake sub-system comprises: at least one brake; a reservoir; and a valve configured to selectively open to allow pressurized air to flow from the reservoir to the at least one brake. The valve is coupled with the output port of the electronic trailer pressure control module, such that the valve receives pressurized air from the output port of the electronic trailer pressure control module when the braking controllers cause the electronic trailer pressure control module to allow pressurized air to flow from the input port to the output port, which cause the valve to open and allow pressurized air to flow from the reservoir to the at least one brake.

In another embodiment, a brake system is provided comprising: an electronic trailer pressure control module comprising an input port and an output port, a braking controller configured to cause the electronic trailer pressure control module to selectively allow pressurized air to flow from the input port to the output port; and a lift axle brake sub-system. The lift axle brake sub-system comprises: at least one brake; a reservoir; and a towed vehicle anti-lock brakes system (TABS) unit comprising a valve configured to selectively open to allow pressurized air to flow from the reservoir to the at least one brake. The valve is coupled with the output port of the electronic trailer pressure control module, such that the valve receives pressurized air from the output port of the electronic trailer pressure control module when the braking controllers cause the electronic trailer pressure control module to allow pressurized air to flow from the input port to the output port, which cause the valve to open and allow pressurized air to flow from the reservoir to the at least one brake.

In yet another embodiment, a vehicle is provided comprising: a towed vehicle braking system; a lift axle; and means for braking the lift axle by treating the lift axle as a towed vehicle whose braking is controlled by the towed vehicle braking system.

Other embodiments are possible, and each of the embodiments can be used alone or together in combination.

### DETAILED DESCRIPTION

### Introduction

The following embodiments relate to a brake system for a lift axle. As mentioned above, the amount of load a truck can carry is typically constrained by the number of axles on the truck. A lift axle can be provided on a truck during or after manufacturing to allow the truck to carry more load. The lift axle can be selectively lifted above the road (e.g., when the truck is empty) and lowered onto the road (e.g., when carrying load requiring an extra axle).

Embodiments relate to braking systems for vehicles. For example, embodiments relate to a system for controlling wheel brakes on a lift axle of a vehicle in which wheel brakes on other axles in the vehicle are controlled using an electronic-over-air brake subsystem (hereinafter referred to as electronic braking system (EBS)). In this document, one version of EBS will be referred to as Global Scalable Brake Control (GSBC).

The use of electronic braking systems to control wheel brakes in vehicles is continuously increasing. As compared to conventional fluid control of wheel brakes, electronic braking systems offer several advantages. Electronic braking systems shorten the response time between a brake command and application of the brakes because electrical control signals travel faster than fluid control signals. Electronic braking systems also allow more accurate control of brake pressure due to the use of pressure sensors and other feedback systems. Electronic brake systems also allow brake pressure to be set independently of the position of operator controls such as brake pedals.

There are various challenges in designing a braking system for a lift axle. For example, certain brake controllers (e.g., GSBC controllers) may require a detailed configuration of the vehicle to be programmed into it. This can be a challenge when a lift axle is installed on a truck aftermarket by a facility or a technician who does not know how to program the controller and/or what data to program into the controller. The following embodiments provide a lift axle brake system that can overcome these challenges. In one embodiment, a brake system is used that is based on a brake system used to control the brakes on a towed vehicle (e.g., trailer, dolly, towing trailer or other towed vehicle) towed by a towing vehicle (e.g., tractor or other type of towing truck). Before turning to this and other embodiments, the following section provides a brief overview of an example braking system.

### Overview of Example Braking System

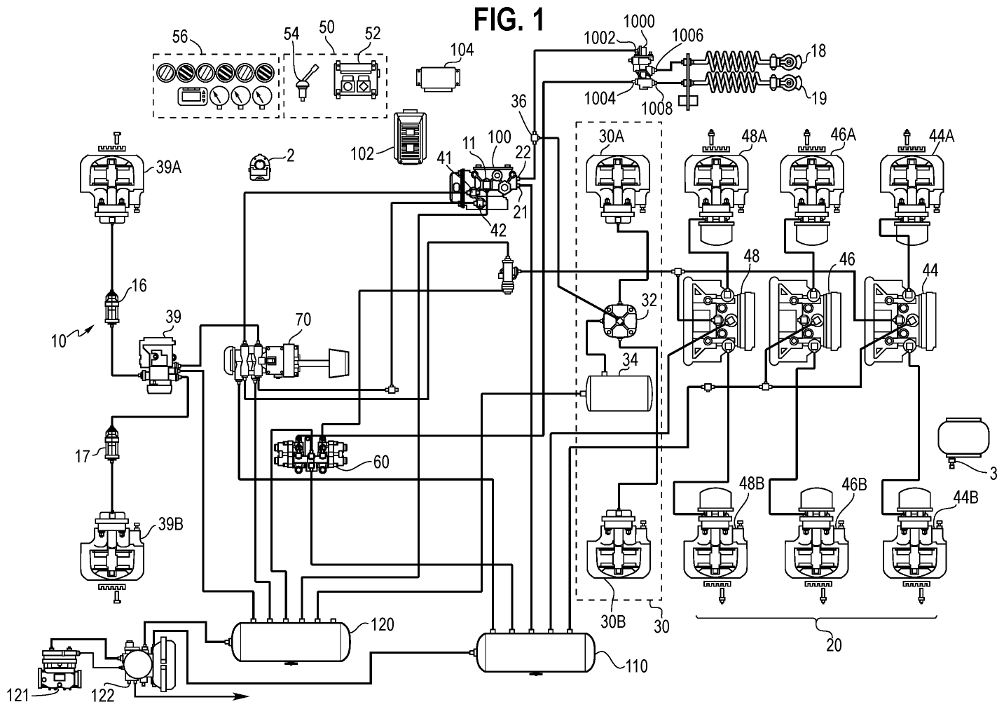

Turning now to the drawings, FIG. 1 is a block diagram of a vehicle of an embodiment. The vehicle can take any form. In one example embodiment, the vehicle is a towing vehicle that is capable of towing a towed vehicle or other towed vehicle and has a front undriven (steer) axle 10, one or more rear axles 20 (at least one of which can be a driven axle), and a lift axle 30. While a single lift axle is shown in FIG. 1, it should be understood that the vehicle can comprise more than one lift axle with appropriate modifications made to the lift axle braking system discussed below. Also, as will be explained in more detail below, the vehicle can take other forms, such as, but not limited to, a truck that is not capable of towing a towed vehicle.

As shown in FIG. 1, in this embodiment, the braking system comprises an electronically-controlled electronic trailer pressure control module 100 (referred to herein as an eTPCM), a braking controller 102, and an overall vehicle controller 104, As used herein, a “controller” (or an “electronic control unit”) can comprise one or more processors that can execute computer-readable program code having instructions (e.g., modules, routines, sub-routine, programs, applications, etc.) that, when executed by the one or more processors, individually or in combination, cause the one or more processors to perform certain functions, such as some or all of those discussed herein. The computer-readable program code can be stored in a non-transitory computer-readable storage medium, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. The one or more processors can also take the form of a purely-hardware implementation (e.g., an application-specific integrated circuit (ASIC)).

The braking system of this embodiment also comprises a dash control module 50 that may comprise of a parking controller 52 and/or an electronic towed vehicle hand control 54, dash displays 56, a park valve module 60, a foot brake module 70, a rear service air reservoir 110, and a front service air reservoir 120. In one embodiment, this braking sub-system is located on a towing vehicle and pneumatically communicates with a braking system of a towed vehicle via gladhands 18, 19. Other components of the vehicle's braking system (such as the towing vehicle's service and parking brakes) are not shown to simplify the drawing.

The rear and front service reservoirs 110, 120 of the braking system are configured to store pressurized air that is supplied by a compressor 121 and heated (e.g., in colder climates) by a heater 122, and the pressurized air in these reservoirs 110, 120 is used to supply various braking components on the towing vehicle and the towed vehicle. In this embodiment, the rear service reservoir 110 is part of a braking circuit that provides pneumatic pressure to the braking components of the rear and lift axles 20, 30 of the towing vehicle, and the front service reservoir 120 is part of a separate braking circuit that provides pneumatic pressure to the braking components of the front axle 10 of the towing vehicle. Depending on the configuration of the vehicle, either reservoir 110, 120 could be used to supply liftable axle(s). Accordingly, the braking system of the towing vehicle of this embodiment has two isolated braking circuits.

The rear and front service reservoirs 110, 120 are coupled with respective valves in the foot brake module 70 via air hoses (lines) or the like. The foot brake module 70 comprises a brake pedal (e.g., a suspended pedal, where the valve is mounted above the pedal, or a treadle, which pivots directly on the valve mounted below the treadle). Actuation of the brake pedal causes the two valves to open proportional to the amount of actuation of the brake pedal, which caused pneumatic pressure supplied from the rear and front reservoirs 110, 120 to be supplied out of outlet ports of the foot brake module 70 in proportion to the amount of actuation of the brake pedal. The outlet ports of the foot brake module 70 are coupled with service brake components (not shown) of the towing vehicle.

The foot brake module 70 can also provide signals to the braking controller 102 that represent the amount of actuation of the brake pedal. For example, in one embodiment, the foot brake module 70 comprises one or more sensors that measure how much stroke a driver indicates by pressing the brake pedal and transmit electronic signals representing that displacement, which represents a driver brake demand, to the braking controller 102. In one embodiment, the foot brake module 70 contains two sensors, one that increments up and one that increments down as the brake pedal is pressed. These two opposing signals can be used as an error detection mechanism, as the braking controller 102 can detect an error if the two signals it receives from the foot brake module 70 are not opposing. Also, in one embodiment, the foot brake module 70 generates a signal even when the brake pedal is not pressed (such signal would represent zero braking). That way, if the braking controller 102 receives no signal whatsoever from the foot brake module 70, the braking controller 102 can assume there is a fault or error in the foot brake module 70 or communication channel (which, in one embodiment, can be a direct, point-to-point communication channel, such as a universal asynchronous receiver-transmitter (UART) link). It should be understood that any suitable implementation of a foot brake module can be used, and a foot brake module can contain more or different components than those described herein.

In operation, when the brake controller 102 receives electronic brake request signals, the brake controller 102 maps the signals representing the displacement to a requested deceleration and commands to electro-pneumatic modules (EPMs) 39, 44, 46, 48 on the undriven and rear axles 10, 20 to apply the appropriate amount of pressure needed to achieve that deceleration given various variables, such as, but not limited to, vehicle weight, weight distribution, whether a towed vehicle is present, and driving conditions. (The braking of the lift axle 30 will be discussed in a subsequent section.) In an EBS, relays and modulators on an axle can be combined into an EPM, which is capable of electronically applying, holding, and releasing air to decelerate a wheel end of the axles. The EPMs 39, 44, 46, 48 can cause the vehicle to decelerate in any suitable way. For example, in the embodiment shown in FIG. 1, the EPMs 44, 46, 48 on the second set of axles 20 are two-channel EPMs. EPM 44 communicates with friction brakes (here, air disc calipers 44A, 44B) on each braked wheel end of the steer axle, while EPMs 46, 48 control air disc calipers 46A, 46B, 48A, 48B on each braked wheel end of the optional axle. While disc brakes are shown in the illustrated example, it is to be understood that any foundation brake technology compatible with a pneumatic brake system is also contemplated. The EPM 39 on the undriven axle 10 in this example is a one-channel EPM that communicates, via modulators 16, 17, with air disc calipers 39A, 39B on each braked wheel end of the undriven axle. Rear and front reservoirs 110, 120 can provide pneumatic supply pressure to the EPMs 39, 44, 46, 48. The system also includes a steer-angle sensor 2, which can detect the angle of the steering wheel (e.g., to detect if the vehicle is driving straight or is driving through a curve), as well as an axle load sensor 3.

Pneumatic signals for controlling the service and parking brakes can be applied to the towed vehicle via the pneumatic control and supply lines 18, 19. This allows the braking system to control braking of the towed vehicle towed by the towing vehicle. That is, in addition to applying pressurized air to the service brakes of the towing vehicle, pressurized air from the foot brake module 70 is also sent to the towed vehicle via gladhand 18 to provide a control signal to actuate brakes on the towed vehicle. In this embodiment, gladhand 19 is used to supply pressurized air from the rear or front service reservoirs 110, 120 to the towed vehicle, and that air is used to supply pressure to the control valves that deliver service brake air to the brakes on the towed vehicle in response to pneumatic control signals received via gladhand 18. Pressurized air from gladhand 19 is also used to release the parking brakes of the towed vehicle. In this embodiment, the towed vehicle has spring brakes that place the towed vehicle in a parked state in the absence of pressurized air. To release the parking brakes on the towed vehicle, a driver can cause pressurized air to flow on the supply line of gladhand 19, and that air is applied to the spring brakes in the towed vehicle to un-park the towed vehicle. For example, the dash control module 50 can comprise a push-pull button that, when pushed in, causes the park valve module 60 to open. (Another push-pull button on the dash control module 50 can cause the park valve module 60 to apply air to release the spring parking brakes in the towing vehicle) The park valve module 60 receives pressurize air from the rear and front service reservoirs 110, 120, and the greater pressure is applied from the park valve module 60 in response the push-pull button being pushed in. That air is sent, via gladhand 19, to the towed vehicle to release the spring parking brakes. The park valve module 60 can also detect the pressure being supplied out of gladhand 19. If that pressure is not above a threshold pressure, the valve in the park valve module 60 closes, preventing supply air from being provided out of gladhand 19.

As mentioned above, in addition to un-parking the spring brakes of the towed vehicle, the pressurized air on the service line can be used to actuate the service brakes of the towed vehicle in response to a pneumatic control signal supplied on the control line to gladhand 18. In one embodiment, the pressurized air from gladhand 19 is used to fill reservoir(s) in the towed vehicle, and the pneumatic control signal supplied on gladhand 18 causes air to flow from the reservoir(s) to the braking components on the towed vehicle. The eTPCM 100 can be used to supply the pneumatic control signal to the towed vehicle.

As shown in FIG. 1, the eTPCM 100 comprises inlet ports 41, 42 (with single check valves, not shown) that receive pressurized air from the rear and front service reservoirs 110, 120 in response to actuation of the brake pedal of the foot brake module 70. The eTPCM 100 also receives pressurized air from the front service reservoir 120 via port 11 (the pressure from the service reservoirs is proportionally applied). Based on the amount of pressurized air received from the foot brake module 70 and/or control signals from the braking controller 102 for electronic braking, the eTPCM 100 causes a proportional amount of pressurized air received from the rear and front service reservoirs 110, 120 to output at port 22, which is coupled with the control line that leads to gladhand 18. This supplied air is the control air sent to the towed vehicle to control the towed vehicle's braking system. The eTPCM 100 also comprises port 21, which is coupled with the rear service reservoir 110.

A towing vehicle protection valve (TPV) 1000 comprises two (2) input ports including i) a towing vehicle control port 1002 (e.g., a tractor control port) and ii) a towing vehicle supply port 1004 (e.g., a tractor supply port) that receive pressurized air from the eTPCM outlet port 22 and the parking control valve 60, respectively. The TPV 1000 also comprises two (2) delivery ports including i) a towed vehicle control port 1006 (e.g., a trailer control port) and ii) a towed vehicle supply port 1008 (e.g., a trailer supply port) that are coupled to, and fluidly communicate with, the gladhands 18, 19, respectively, of the towing vehicle. The TPV 1000, depending upon the pressure present at the towing vehicle supply port 1004 and the towed vehicle supply port 1008 may be used to prevent or control the venting control air when a towed vehicle is not connected to the towing vehicle. This is referred to herein as “towing vehicle protection.” In this embodiment, a T-connector 36 is provided in the line between the output port 22 of the electronically-controlled eTPCM 100 and the gladhand 18. While a T-connector 36 is shown in the example, other connectors can be used, such as a connector on a TPV or a dedicated port on the eTPCM 100. Although the illustrated embodiment shows the TPV 1000 and eTPCM 100 as separate devices, it to be understood that the TPV 1000 and the eTPCM 100 can be integrated into a single device (e.g., the TPV 1000 may be integrated into the eTPCM 100).

### Overview of Challenges with Lift Axle Braking

As mentioned above, the vehicle in this example comprises a lift axle 30. Before discussing the braking system used in this embodiment to brake the lift axle 30, this section provides an overview of the challenges involved in lift axle braking.

It may be desired for the brake controller 102 to control the braking of the lift axle 30 as it does with the other axles 10, 20. However, some brake controllers, such as Global Scalable Brake Control (GSBC) controllers, have a limited number of axles that it can control via EPMs to control the air pressure to each wheel end. Further, electronic brake system (EBS) controllers typically must be configured for each unique vehicle application, ideally at end-of-line at the vehicle manufacturer's plant. Determining the correct configuration may involve analysis, testing, and simulation to determine the correct end-of-line configuration.

These characteristics of EBS can conflict with the desires of the North American market, in which the vehicle original equipment manufacturers (OEMs) want legally-compliant performance with a minimum amount of application work and a minimum incremental expense for adding lift axles to a vehicle. Therefore, there is a desire to produce vehicles with lift axles but no additional EPMs or wheel speed sensors.

Furthermore, trucks are often built by the OEM with no lift axles and then purchased to be modified for a specific vocation. This typically involves “body builders” installing equipment such as lift axles and other equipment. Most, if not all, body builders do not possess the technical equipment or experience to test, calibrate and reconfigure the EBS brake controller to accommodate additional axles or other vehicle configuration changes. And, in some cases, the number of lift axles installed may be beyond what can be accommodated by EBS using the current system design.

Electronic Braking Systems are typically configured so the controller (e.g., the electronic control unit (ECU)) has an accurate definition of the vehicle in terms of the number of axles present, the type of axle (e.g., steer, drive, liftable), the friction brakes on each axle, and the air pressure versus load characteristic of the air suspension, if so equipped. This vehicle definition enables the system to use a multitude of inputs and sophisticated algorithms to determine the appropriate amount of brake pressure to be delivered to each wheel end. These inputs include total wheel speed, vehicle mass, axle load, friction brake performance, powertrain retardation performance, and driver's braking demand.

For vehicles equipped as built by the vehicle OEM, such ECU configuration can be accomplished using a combination of the OEM's bill of materials from the vehicle assembly process, in combination with a programming station that can set values for the needed ECU parameters at the end of the manufacturing line, also called End of Line (EOL) configuration. Valid vehicle configurations are limited by the total amount of discrete input-output (IO) for the EBS ECU and EPMs, as well as software characteristics.

So, in some environments, the brake controller may need to accommodate the following example features:

1. Lift axles that are installed in the OEM plant. These axles are not equipped with wheel speed sensors. This lack of wheel speed sensors may prevent addition of an EPM to the lift axle.

2. An expansive set of vehicle configurations in terms of lift axle quantity, type (e.g., self-steering vs. non-steering), location (forward or aft of the drive axles), friction brakes (e.g., drum vs. disc), and tires.

3. Lift axles that may be equipped with wheel speed sensors and towed vehicle anti-lock brakes system (TABS) units for slip control, which is a common practice at some “body builders.”

An example minimum level of performance that may be required can be characterized as:

1. All lift axles must be braked.

2. All lift axles must be able to receive full reservoir pressure if commanded by the driver.

3. Pneumatic brake apply and release performance must be consistent with the requirements of Federal Motor Vehicle Safety Standard (FMVSS) No. 121, as applicable, which requires a vehicle to comply with certain performance limits.

4. Brake activation on the lift axles must not unacceptably degrade directional control of the vehicle.

An example enhanced level of performance that may be desired in some applications include:

1. Brake actuations conducted in a way that will minimize damage to tires.

2. Compatibility with slip control via a TABS unit controlling one or more lift axles.

Given the high degree of variability in potential vehicle configurations and the high degree of variability in braking performance from the lift axles on a given vehicle (because of variable normal force on the axles), the GSBC system may need to be able to automatically compensate during service braking, without diagnostics being triggered or other errors occurring.

One potential braking strategy involves tailoring the vehicle characterizations in real-time based on measurement of the lift axle loads using air suspension pressure measurements. Although this approach is possible, it may require software changes and application engineering that may be extensive, resulting in a costly solution that may have little advantage in performance relative to today's lift axle control. Furthermore, this strategy may likely not be able to accommodate the entire gamut of lift axle configurations on North American vehicles today.

### Example Lift Axle Braking System

The embodiments presented herein provide a system design and control strategy whereby the lift axles on the power unit are controlled using an existing towed vehicle control channel in a GSBC system. This channel is controlled in a way that automatically compensates for unknown factors that exist when towing a towed vehicle, such as, for example: the number of axles, friction brake characteristic on each axle, and normal force carried by each axle. Furthermore, there can be a degree of feed-forward slip control available using a brake pressure pulsing characteristic.

From the perspective of the GSBC controller, the braking performance of the lift axles on a solo vehicle would “appear” to be much like that of a towed vehicle. In a braking event, the GSBC system can predict an amount of retardation from the friction brakes controlled by the EPMs on the vehicle. Using the vehicle mass, friction brake characteristics, brake pressures, and other inputs, the GSBC ECU already determines the retardation that is needed from the towed vehicle to meet the driver's demand and calculates an estimate of what pressure should be delivered to the towed vehicle. This functionality can still be applicable in that, from a longitudinal vehicle dynamics perspective, there are many similarities between a solo truck with lift axles and a towing-towed vehicle. For example, both the solo vehicle and the combination vehicle have a number of axles proportional to the total vehicle mass, each axle carries a portion of the load, and each axle has brakes sized according to the amount of load carried by the axle.

Various embodiments can be used to allow this control strategy to be accomplished. For example, a solo vehicle can be equipped as a towing vehicle, in that it would be equipped with an eTPCM 100 and the appropriate supporting equipment such as a towing vehicle protection valve, if necessary.

For example, turning again to FIG. 1, the electronically-controlled eTPCM 100 has an output port 22 that provides a pneumatic control signal (pressurized air) to the gladhand 18. As discussed above, this pneumatic control signal causes air to flow from the reservoir(s) to the braking components on the towed vehicle. In this embodiment, the T-connector 36 is provided in the line between the output port 22 of the electronically-controlled eTPCM 100 and the towing vehicle control port 1002 of the TPV 1000. While the T-connector 36 is shown in the example, other connectors can be used, such as a connector on a towing vehicle protection valve.

The T-connector 36 supplies air from the output port 22 of the electronically-controlled eTPCM 100 to a valve (e.g., a relay valve) 32 in the lift axle. So, actuation of the service brakes of the vehicle causes a pneumatic control signal to be supplied both to the gladhand 18 (to control braking on the towed vehicle) and the relay valve 32 (to control braking on the lift axle 30). The pneumatic control signal causes the relay valve 32 to open, allowing pressurized air in a tank in the lift axle sub-system 30 to flow to the air disc calipers 30A, 30B on each braked wheel end of the lift axle 30 to brae the lift axle 30.

So, in this embodiment, the eTPCM delivery port 22 is connected to the lift axle brakes via an arrangement of valves that may include relay valves, quick release valves, or other valves. Pressure control is performed as it is done for towed vehicles in the North American market. Closed loop slip control is not performed in this example, but some slip regulation may be accomplished on an open-loop basis using the brake pressure pulsing characteristic.

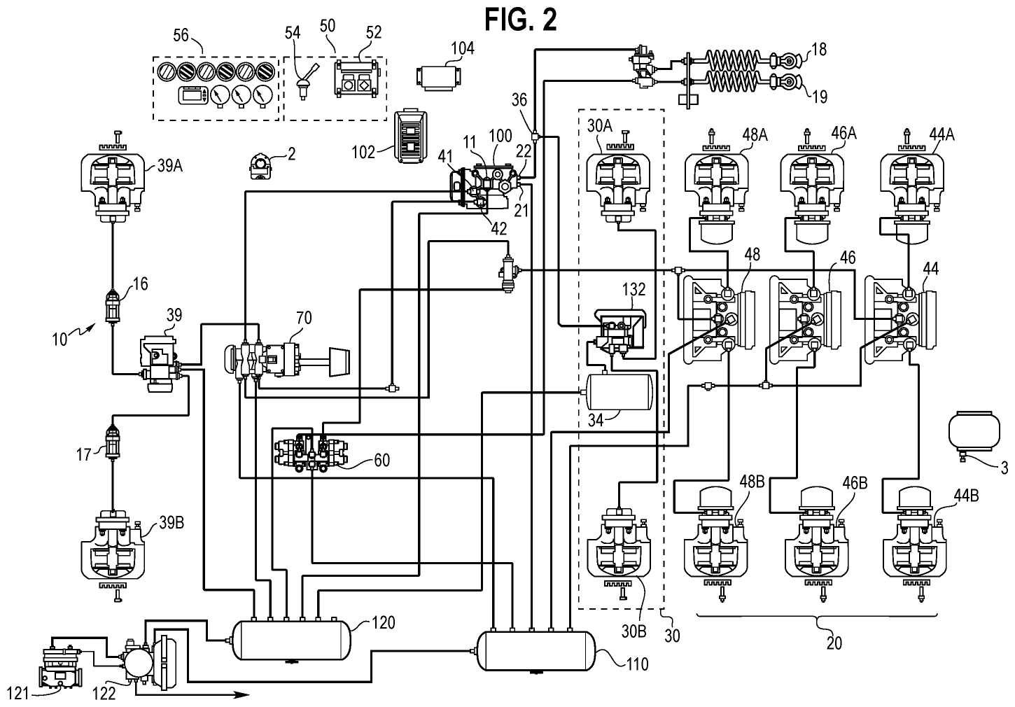

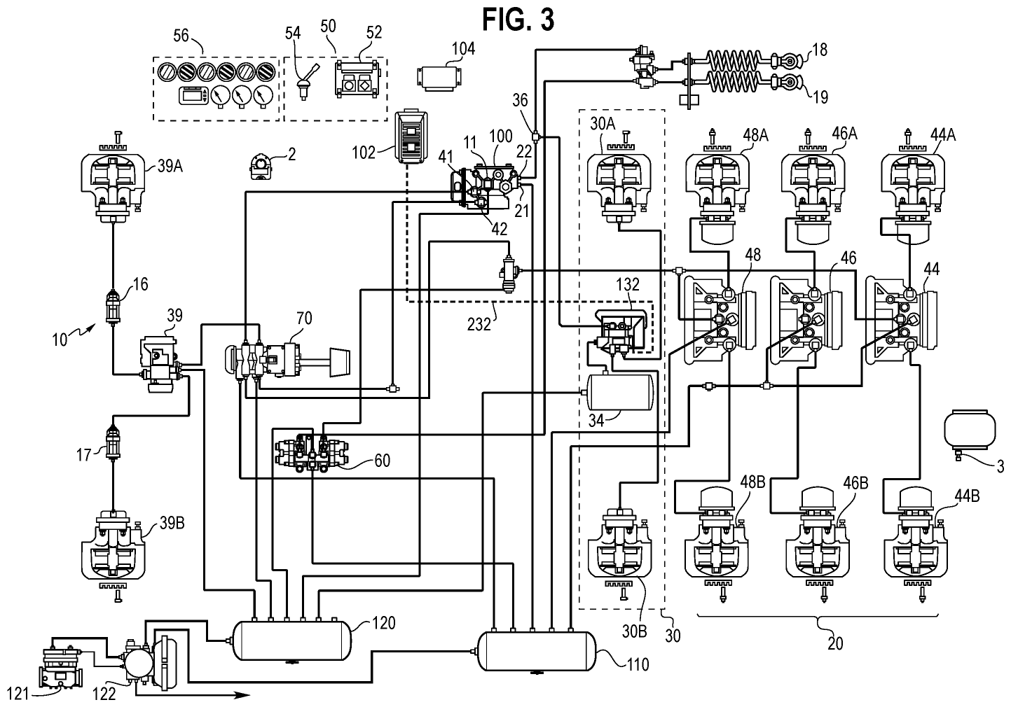

Many alternatives can be used. For example, in the embodiment shown in FIG. 2, instead of the pneumatic control signal being supplied to a relay valve, it is supplied to a towed vehicle anti-lock brakes system (TABS) unit 132 on the lift axle 30. The TABS unit 132 can use wheel speed sensors to perform closed-loop slip control on the axle(s). In yet another embodiment (shown in FIG. 3), the TABS units 132 is connected to the brake controller 102 via a trailer controller area network (CAN) 232, similar to the connection used for European towing-towed vehicles. This would provide advantages in the speed and accuracy of brake application and would potentially achieve comparable performance to direct control of the lift axles by GSBC EPMs.

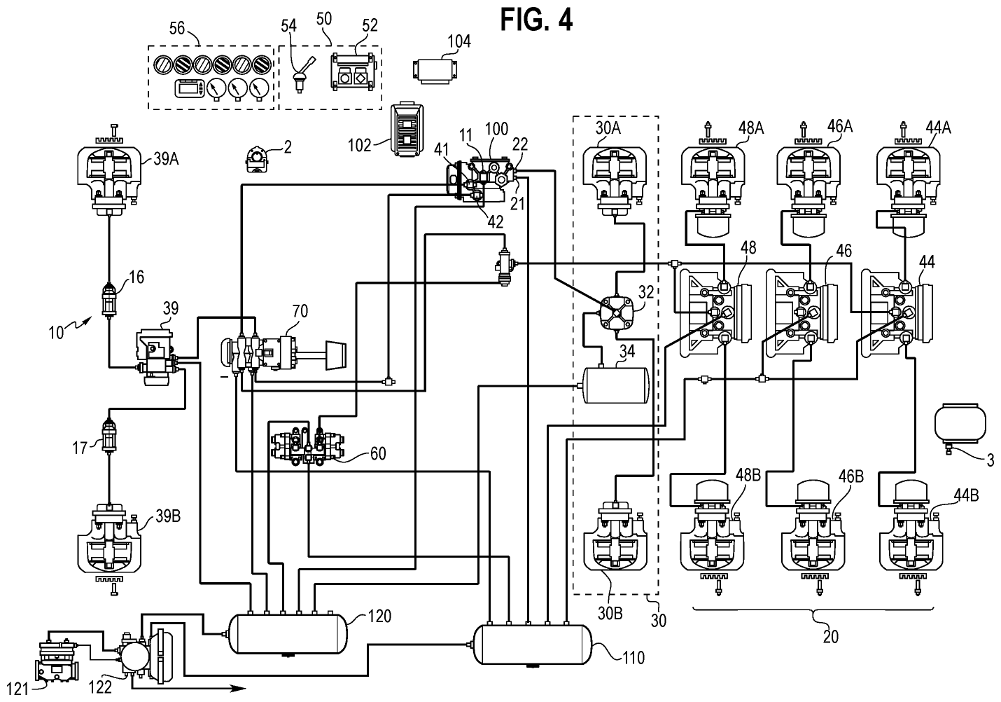

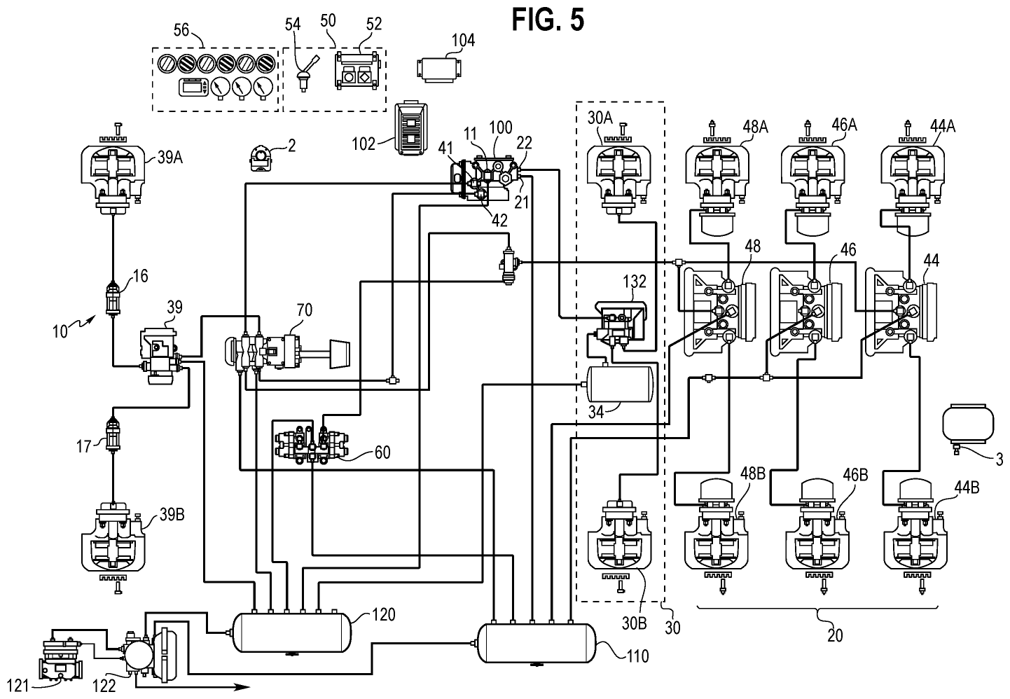

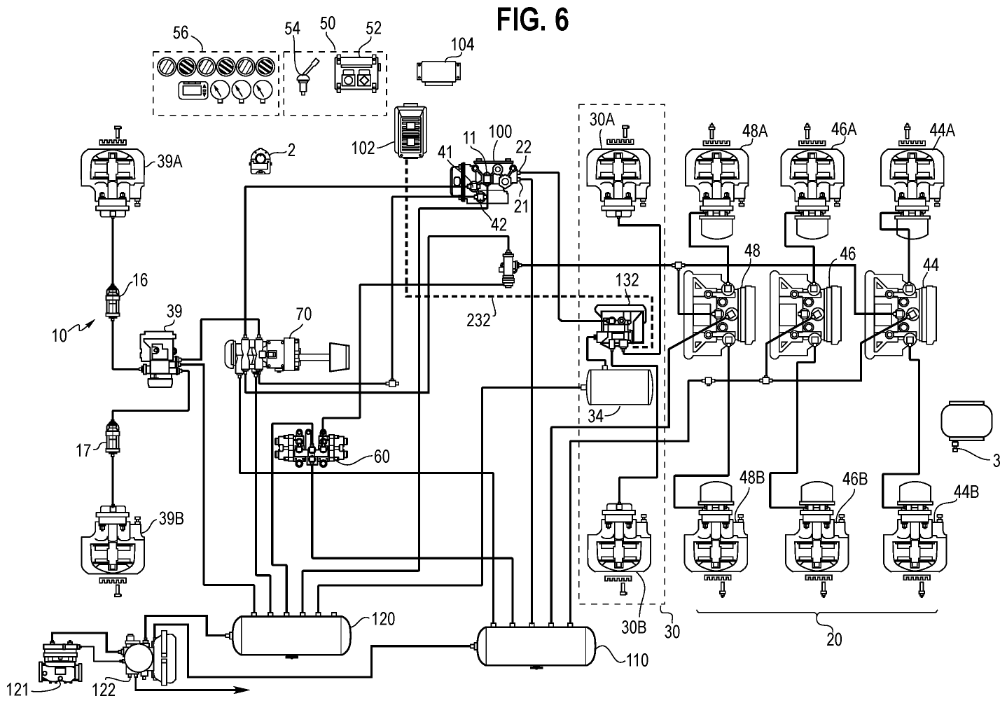

Other alternatives are possible. For example, while the vehicle in FIGS. 1-3 took the form of a towing vehicle capable of towing a towed vehicle, the lift axle braking system of these embodiments can be used with a truck that is not capable of towing a towed vehicle (e.g., a towing vehicle does not carry load without a towed vehicle, whereas a truck may carry load itself, in the absence of a towed vehicle). An example of this embodiment is shown in FIG. 4, where the pneumatic control signal is being supplied directly to the relay valve 35 from the output port 22, as there are no gladhands present for the output port to supply air to. The various alternatives discussed above can be used with this embodiment too. For example, as shown in FIGS. 5 and 6, a TABS unit 132 can be used without (FIG. 5) and with (FIG. 6) a CAN-connection to the brake controller 102.

There are many advantages associated with these embodiments. For example, these embodiments can allow vehicles to be built in an OEM plant with lift axles, without adding EPMs or wheel speed sensors, or reconfiguring EBS parameters. These embodiments can also allow lift axles to be added to the vehicle later, without adding EPMs or wheel speed sensors, or reconfiguring parameters. Further, these embodiments can allow enhanced performance with towed vehicle or other ABS control on lift axles to be achieved, if desired.

### CONCLUSION

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A brake system comprising:
an electronic trailer pressure control module (eTPCM) comprising an input port and an output port;
a braking controller configured to cause the eTPCM to selectively allow pressurized air to flow from the input port to the output port; and
a lift axle brake sub-system comprising:
at least one brake;
a valve configured to selectively open to allow pressurized air to flow from the reservoir to the at least one brake;
wherein the valve is coupled with the output port of the eTPCM, such that the valve receives pressurized air from the output port of the eTPCM when the braking controllers cause the eTPCM to allow pressurized air to flow from the input port to the output port, which cause the valve to open and allow pressurized air to flow from the reservoir to the at least one brake.

2. The brake system of claim 1, wherein the output port of the eTPCM is also coupled with a braking system of a towed vehicle.

3. The brake system of claim 1, wherein the lift axle brake sub-system also includes a reservoir.

4. The brake system of claim 2, wherein a T-connector couples an air hose from the valve to air hoses between the output port of eTPCM and the braking system of the towed vehicle.

5. The brake system of claim 2, further comprising a towing vehicle protection valve comprising a connector that couples an air hose from the valve to an air hose coupled with the output port of the eTPCM.

6. The brake system of claim 1, wherein the output port of the eTPCM is not coupled with a braking system of a towed vehicle.

7. The brake system of claim 6, wherein the output port of the eTPCM is directly coupled with the valve via an air hose.

8. The brake system of claim 1, wherein the valve comprises a relay valve.

9. A brake system comprising:
an electronic trailer pressure control module (eTPCM) comprising an input port and an output port;
a braking controller configured to cause the eTPCM to selectively allow pressurized air to flow from the input port to the output port; and
a lift axle brake sub-system comprising:
at least one brake; and
a towed vehicle anti-lock brakes system (TABS) unit comprising a valve configured to selectively open to allow pressurized air to flow from the reservoir to the at least one brake;
wherein the valve is coupled with the output port of the eTPCM, such that the valve receives pressurized air from the output port of the eTPCM when the braking controllers cause the eTPCM to allow pressurized air to flow from the input port to the output port, which cause the valve to open and allow pressurized air to flow from the reservoir to the at least one brake.

10. The brake system of claim 9, wherein the lift axle brake sub-system also includes a reservoir.

11. The brake system of claim 9, wherein the output port of the eTPCM is also coupled with a braking system of a towed vehicle.

12. The brake system of claim 11, wherein a T-connector couples an air hose from the valve to air hoses between the output port of the eTPCM and the braking system of the towed vehicle.

13. The brake system of claim 11, further comprising a towing vehicle protection valve comprising a connector that couples an air hose from the valve to an air hose coupled with the output port of the eTPCM.

14. The brake system of claim 9, wherein the output port of the eTPCM is not coupled with a braking system of a towed vehicle.

15. The brake system of claim 14, wherein the output port of the eTPCM is directly coupled with the valve via an air hose.

16. The brake system of claim 9, wherein the valve comprises a relay valve.

17. The brake system of claim 9, wherein the TABS unit is in electronic communication with the braking controller.

18. The brake system of claim 17, wherein the TABS unit is in electronic communication with the braking controller via a controller area network (CAN).

19. The brake system of claim 9, wherein the TABS unit is not in electronic communication with the braking controller.

20. A vehicle comprising:
a towed vehicle braking system;
a lift axle; and
means for braking the lift axle by treating the lift axle as a towed vehicle whose braking is controlled by the towed vehicle braking system.

21. The vehicle of claim 20, wherein the means for braking comprises
at least one brake; and
a valve configured to selectively open to allow pressurized air to flow from the reservoir to the at least one brake;
wherein the valve is coupled with an output port of an eTPCM, such that the valve receives pressurized air from the output port of the eTPCM when a braking controller cause the eTPCM to allow pressurized air to flow from an input port to the output port, which cause the valve to open and allow pressurized air to flow from the reservoir to the at least one brake.

22. The vehicle of claim 20, wherein the means for braking comprises
at least one brake; and
a towed vehicle anti-lock brakes system (TABS) unit comprising a valve configured to selectively open to allow pressurized air to flow from the reservoir to the at least one brake;
wherein the valve is coupled with an output port of an eTPCM, such that the valve receives pressurized air from the output port of the eTPCM when a braking controller cause the eTPCM to allow pressurized air to flow from an input port to the output port, which cause the valve to open and allow pressurized air to flow from the reservoir to the at least one brake.
